(19) United States
(12) Patent Application Publication
(10) Pub. No.: US 2011/0314395 A1
(43) Pub. Date: Dec. 22, 2011

(54) SEQUENTIAL AND NON-SEQUENTIAL ACCESS TO RECORDS WITHIN A LIST

(75) Inventors: Derik Bjorn Stenerson, Redmond, WA (US); Karin Zimprich, Bellevue, WA (US); Bharath Swaminathan, Renton, WA (US); Gautam Satalkar, Redmond, WA (US); Ted Cyrek, Sammamish, WA (US)

(73) Assignee: Microsoft Corporation, Redmond, WA (US)

(21) Appl. No.: 12/817,186

(22) Filed: Jun. 17, 2010

(51) Int. Cl. G06F 3/048

(52) U.S. Cl. 715/760; 715/781

(57) ABSTRACT

The disclosure provided herein allows a user of a web application to sequentially or non-sequentially open records from a single or multi-page list across page boundaries without leaving the current viewing window. According to one aspect, a list is provided having a number of records presented sequentially in one or more pages of a list. A selection of one of the records is received, and the content associated with the selected record is retrieved and provided. The list is again provided while presenting the content of the selected record. A new record, sequentially or non-sequentially listed with respect to the currently viewed record, is selected from the list, and in response to the selection, the content within the viewing window is replaced with content associated with the newly selected record.

### BACKGROUND

Web applications such as customer relationship management (CRM) systems often provide users with tools for managing large numbers of business-related matters, such as information regarding clients, accounts, sales, marketing, staffing, and more. Utilizing CRM systems, users are commonly able to view records corresponding to many aspects of the business. For example, a sales person may utilize a call list to navigate through a large number of telephone calls that they must make during any given shift. The list may be generated from a database according to some defined criteria. Utilizing a web application such as a CRM system, the sales person would conventionally open a record associated with the first telephone number on the list to view a form having information about the potential client and/or input fields for receiving information input by the sales person. After completing the call, the sales person conventionally closes the form, selects the next entry on the list to open the corresponding form, and repeats the process for each entry on the list.

This process is often laborious due to the limitations of conventional web applications. The typical process of reviewing multiple records within a list includes opening a desired record from a list, which opens in a new window. To view another record, the user returns to the original window containing the list to select another record, which then opens in a new window. This process involves lots of clicking and the users often end up with many windows open in a short amount of time.

A solution to this problem has been to enable navigation to the previous or next item in a list on a certain page. For example, some web applications have allowed a user viewing a record from a list to utilize a “previous” or “next” button or other selectable interface element to navigate to the record within the list that is sequentially before or after the current record being viewed. This solution presents two problems.

First, the navigation is restricted to a single page of records within the list. Web applications restrict lists to a predefined number of records or entries. If the number of records exceeds the predefined number allowed on a single page of a list, then the listing of records continues on a subsequent page of the list. When a user has navigated through the records on a single page of the list, the user must then return to the original window with the list, retrieve the record listing for the next page of the list, and then open a record on the new page to continue the navigation through the records.

A second problem with conventional solutions is that the navigation through a page of the list of records is limited to sequential navigation and does not allow for non-sequential navigation. In other words, the user must sequentially work through the list using “previous” and “next” buttons and cannot directly open a record that is not adjacent to the current record in the list without navigating back to the original window and opening the desired item in a new window after locating it on the correct page of the list.

It is with respect to these and other considerations that the disclosure made herein is presented.

### SUMMARY

Sequential and non-sequential access to records or other entries within a list is disclosed herein. In particular, the disclosure below provides users with the ability to access a list of records from which the current record being viewed was opened from, without having to leave the current viewing window. Records or items that are on subsequent or previous pages of the list are available for access, enabling a cross browser window navigation. After opening a record from the list in a viewing window, that same list is also available in the viewing window while viewing the opened record. Using the features described herein, users can now sequentially and randomly select and navigate to any record or item that is on any particular list. The users no longer have to leave the current window in order to select another record from the same list, even if the desired record is on a different page of the list.

According to one aspect presented herein, a list is provided having a number of record representations (referred to herein as “records”) presented sequentially in one or more pages of a list. A selection of one of the records is received, and the content associated with the selected record is retrieved and provided. The list is provided while presenting the content of the selected record. A new record from the list is selected, and in response to the selection, the content within the viewing window is replaced with content associated with the newly selected record.

According to another aspect, a selection of a record from a list having a number of records is received. In response, list data is captured corresponding to the contents and state of the list. The contents associated with the selected record are retrieved and provided, and the captured list data is provided for recreation of the list while a user is viewing the content without returning to the original list.

According to another aspect, content is provided by a web application within a viewing window. A multi-page list of records is provided with the content. A selection of one of the records from the list is received. In response to the selection, content associated with the newly selected record is retrieved and is provided in the viewing window, replacing of the original content. Extensible markup language (XML) list data corresponding to attributes of the list is stored. The page of the list that includes the newly selected record is provided with the new content according to the XML list data that was sent with the new content. A request is received for a different page of the list than the page currently being displayed, and the new list page is provided. A selection of a non-sequential record is received, and the corresponding content is provided in the viewing window in place of the current content.

It should be appreciated that the above-described subject matter may also be implemented as a computer-controlled apparatus, a computer process, a computing system, or as an article of manufacture such as a computer-readable storage medium. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a computer network and software architecture diagram that shows aspects of an operating environment for a list access management system disclosed herein;

FIG. 2 is a block diagram illustrating an example of non-sequential record access from a list of records according to one embodiment disclosed herein;

FIGS. 3A-3E are screen diagrams corresponding to the example shown in FIG. 2 of non-sequential record access from a list of records according to one embodiment disclosed herein;

FIG. 4 is a flow diagram illustrating operations for providing sequential and non-sequential access to records within a list according to embodiments disclosed herein; and

FIG. 5 is a computer architecture diagram showing an illustrative computer hardware and software architecture for a computing system capable of implementing the embodiments presented herein.

### DETAILED DESCRIPTION

The following detailed description is directed to concepts and technologies for providing sequential and non-sequential access to records in a list. In particular, the embodiments described below provide a user of a web application to navigate through a list of items or records, either sequentially or non-sequentially throughout multiple pages of the list, and to view content associated with the selected records within a single viewing window of a web browser. As described above, conventional web applications allow users to navigate a list of records and to open the records to view the associated content. However, conventional web applications are restricted in the number of records shown on a single page of a list, and do not provide users with the ability to randomly select records in any order from any page of the list without closing the currently viewed record and returning to the original list.

Utilizing the concepts described below, when a user selects a record from a list, the content of the record is opened in a viewing window and list data, or XML list data, that can be used to recreate that list is persisted in memory. When the user requests the list to select another record, the list is recreated using the XML list data without the user returning to the original page to view the original list. The user may then navigate the list and make a selection of any record, sequentially or non-sequentially, from any page of the list without having to rely on sequential navigation via “previous” and “next” buttons as is the situation with conventional web applications. A newly selected record is provided in the current viewing window, eliminating the burden of repeated opening and closing of windows or additional navigation back and forth to the primary list page.

Throughout this disclosure, the term “record” is used to describe an item in a list. It should be appreciated that a record may include any item that has associated content for viewing by a user. Moreover, while the embodiments are described herein in the context of a web application, such as with a CRM system, the disclosure below is not limited to use within a web application. While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

In the following detailed description, references are made to the accompanying drawings that form a part hereof, and which are shown by way of illustration specific embodiments or examples. Referring now to the drawings, in which like numerals represent like elements through the several figures, aspects of a computing system, methodology, and computer-readable storage medium for providing sequential and non-sequential access to records from a list will be described.

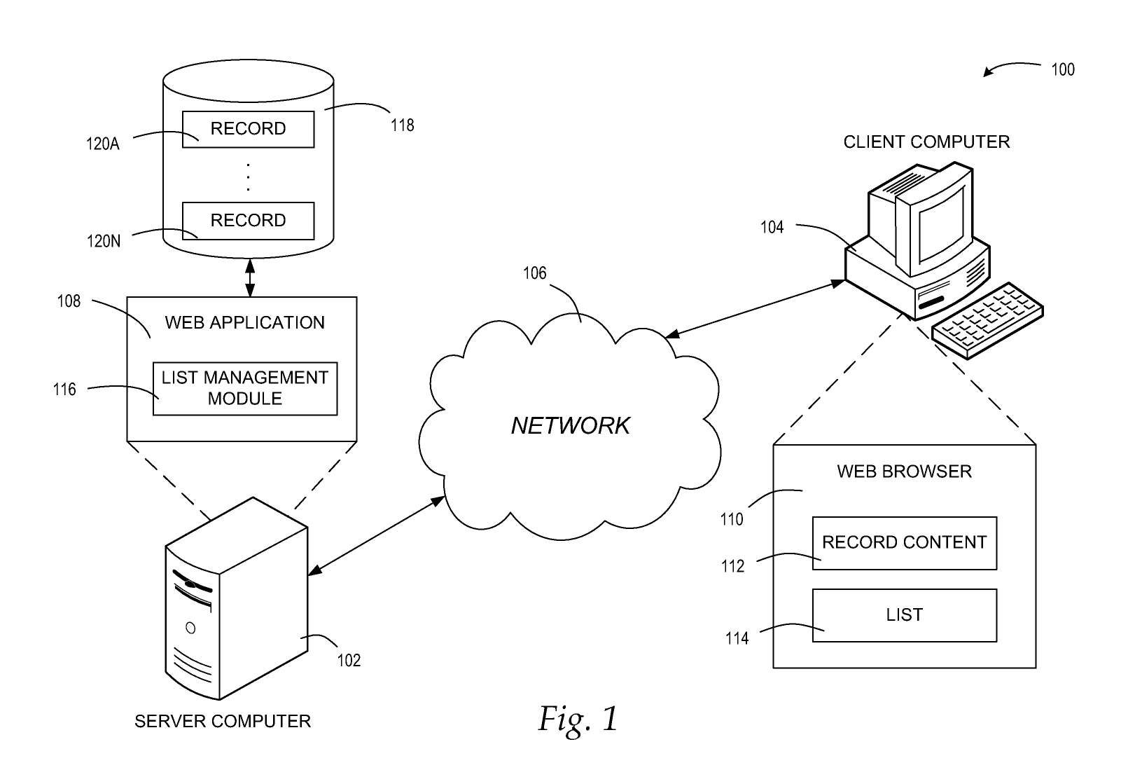

Turning now to FIG. 1, details will be provided regarding one embodiment presented herein for providing access to records from a list. In particular, FIG. 1 is a computer network and software architecture diagram that shows aspects of an operating environment 100 for a computing system that provides the various concepts disclosed herein. The operating environment 100 shown in FIG. 1 includes a server computer 102 communicatively coupled to a client computer 104 by way of a network 106. In the example shown in FIG. 1, the server computer 102 is executing a web application 108. The web application 108 may be any application that is accessed by a user over a network 106, such as the Internet, via a web browser 110 of the client computer 104. The web application 108 may additionally or alternatively be any software application that is coded in a browser-supported language or hosted in a browser-controlled environment.

Using the web browser 110, the client computer 104 is able to access and display record content 112 associated with one of any number of records 120A-120N (referred to generally as records 120) stored in a database 118 or other data repository. It should be appreciated that while the database 118 is shown to be directly linked to the server computer 102 and accessible via the web application 108, the database 118 may include any number of databases 118 communicatively linked to the server computer 102 via the network 106 or multiple networks 106. Moreover, it should be appreciated that although one server computer 102 and one client computer 104 has been shown in FIG. 1, many other computers might be utilized by the embodiments presented herein. Similarly, the various software components described herein might be executed at the server computer 102, the client computer 104, or another suitable computing system.

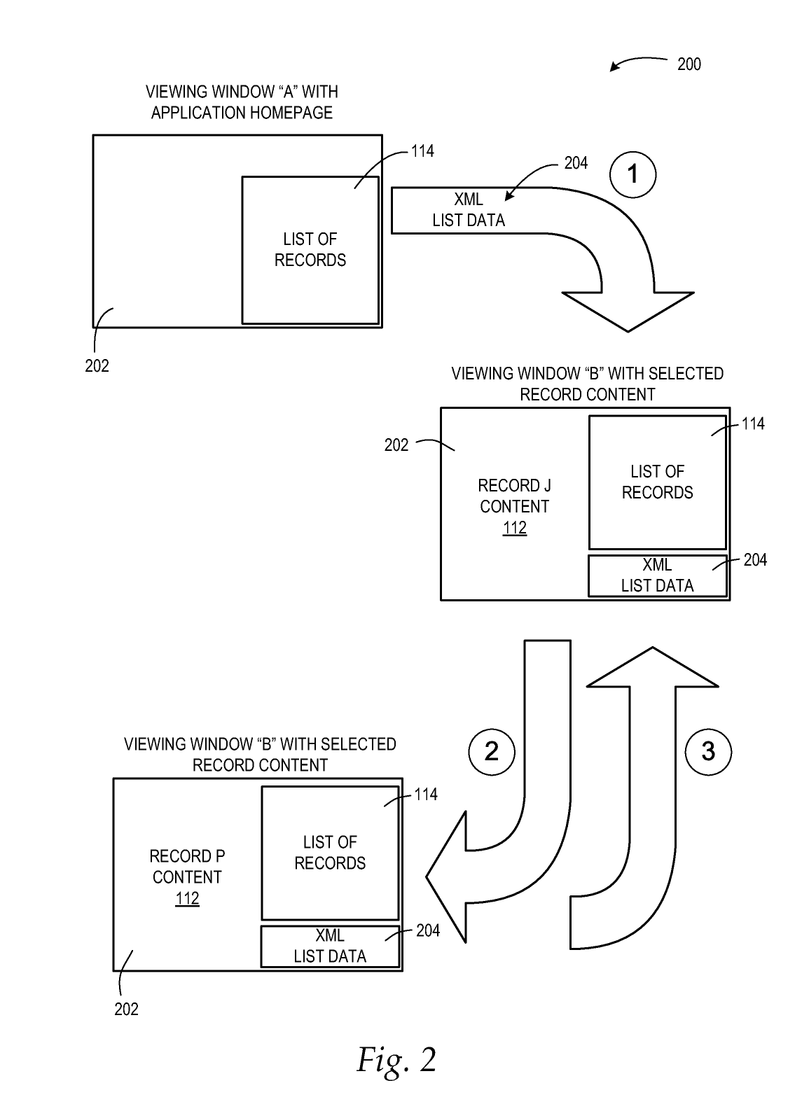

As described briefly above, the web application 108 may provide a list 114 of the records 120, or representations of the records 120, within a viewing window of the web browser 110. This list 114 may be generated by a list management module 116 or other component of the web application 108. The list management module 116 may include routines, programs, components, data structures, and/or other types of structures that perform the various tasks described herein with respect to creating, maintaining, and navigating the list 114, as well as capturing and storing list data that is used in the manner described herein to create user-requested lists 114 in a current viewing window. Additional details regarding these and other features provided herein will be described below with reference to FIGS. 2-5. It should be appreciated that the architecture illustrated in FIG. 1 is merely illustrative and should not be construed as limiting the embodiments presented herein in any way.

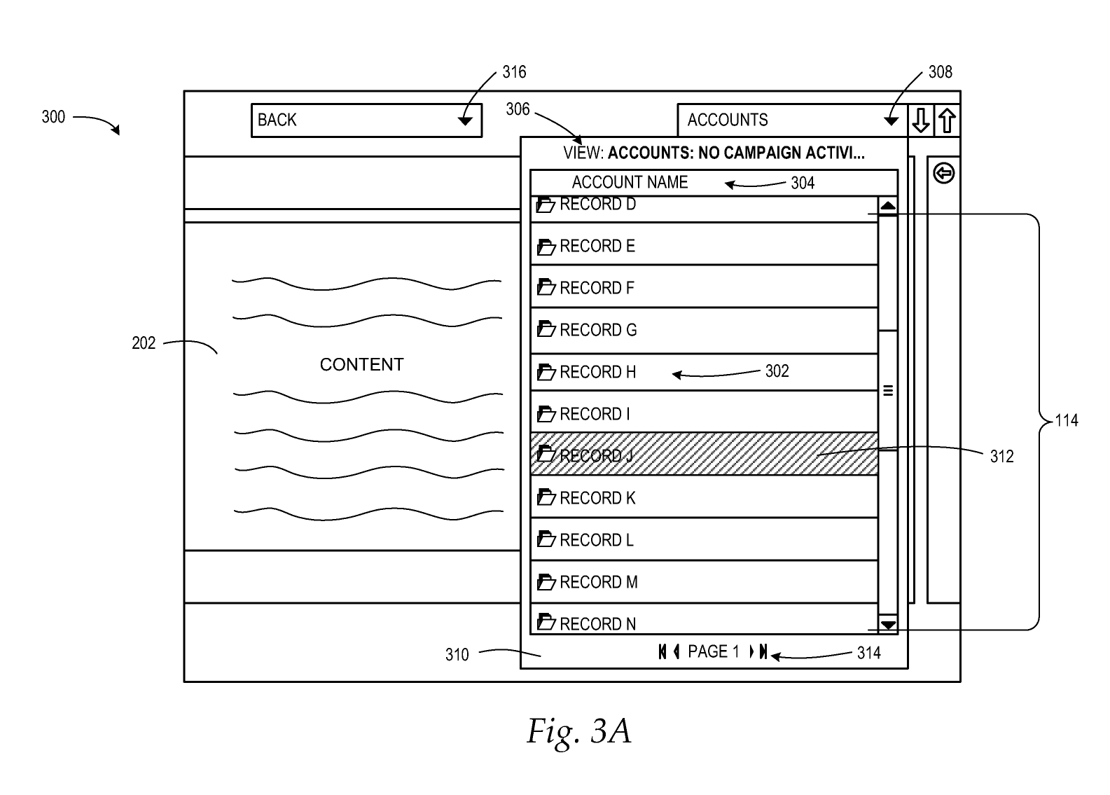

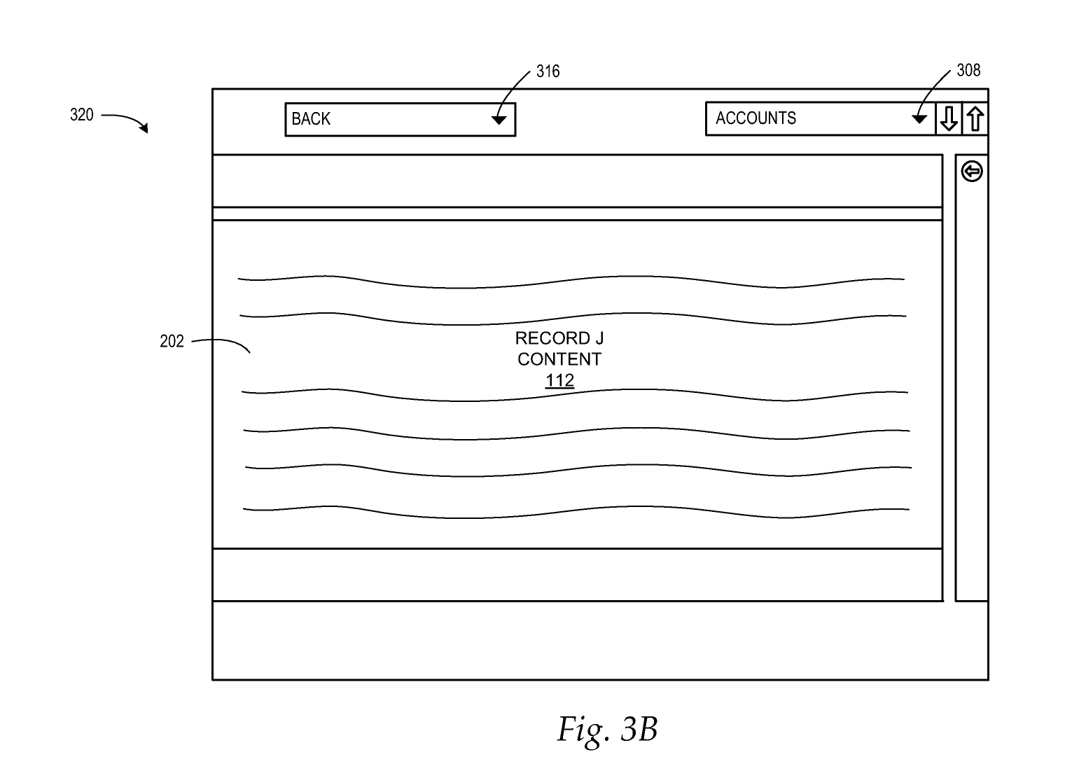

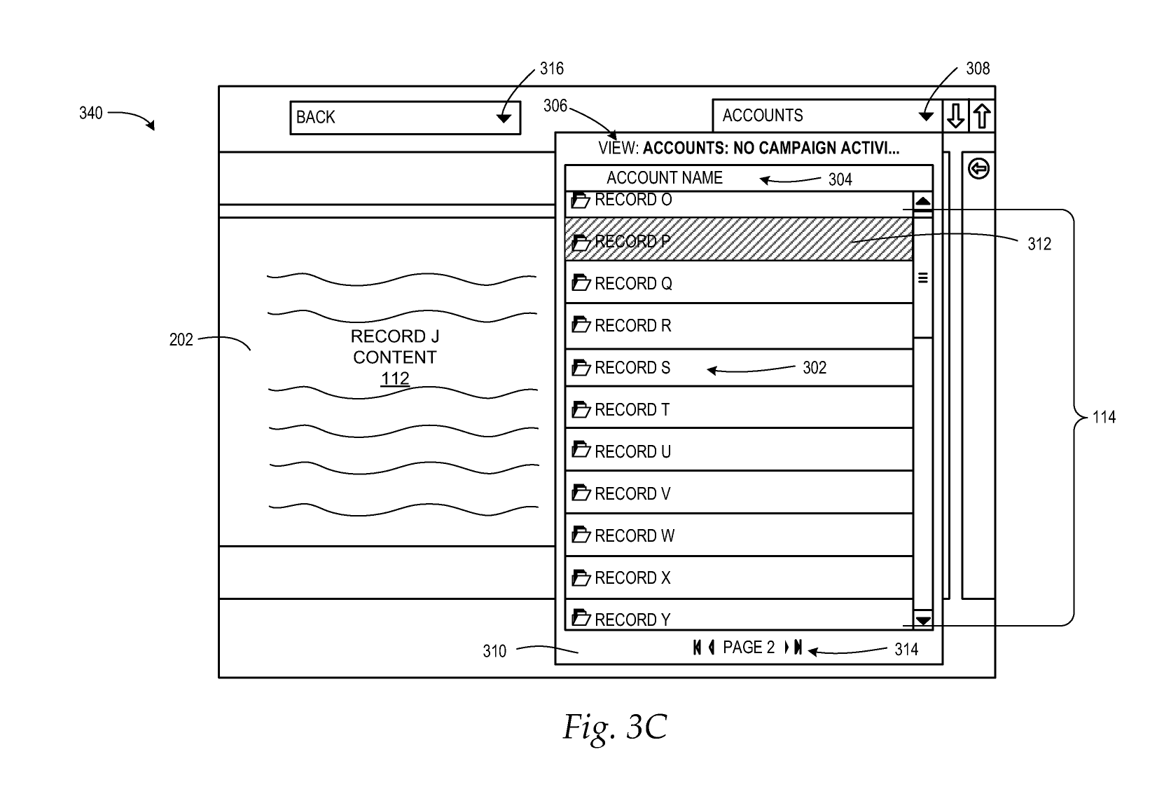

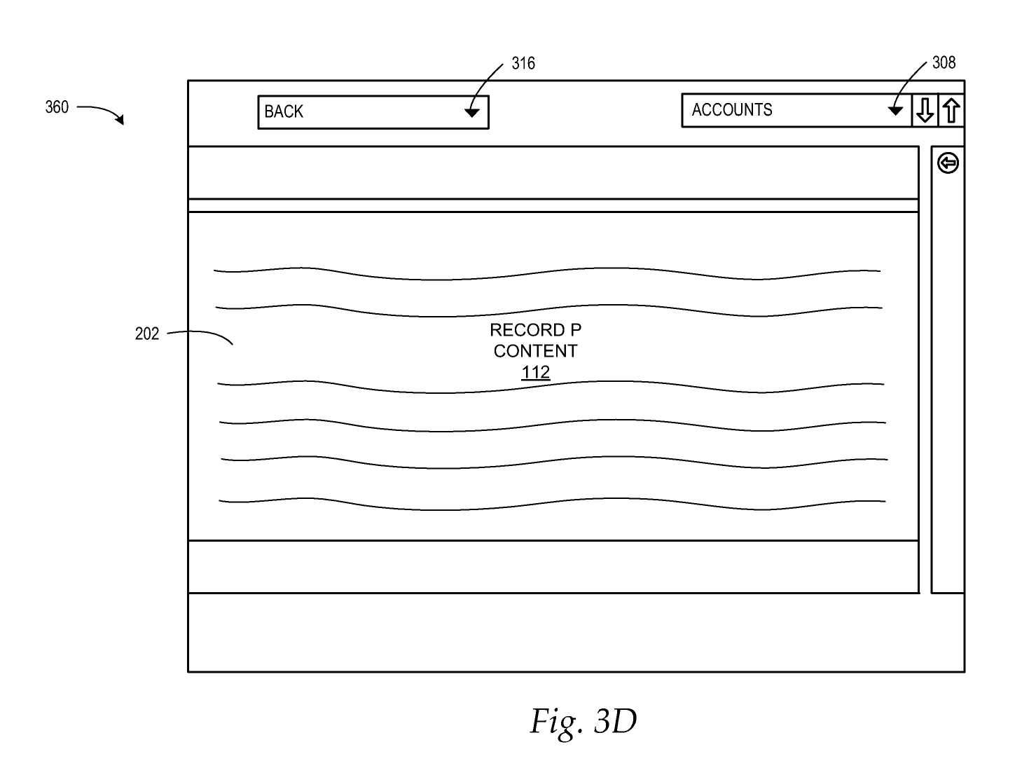

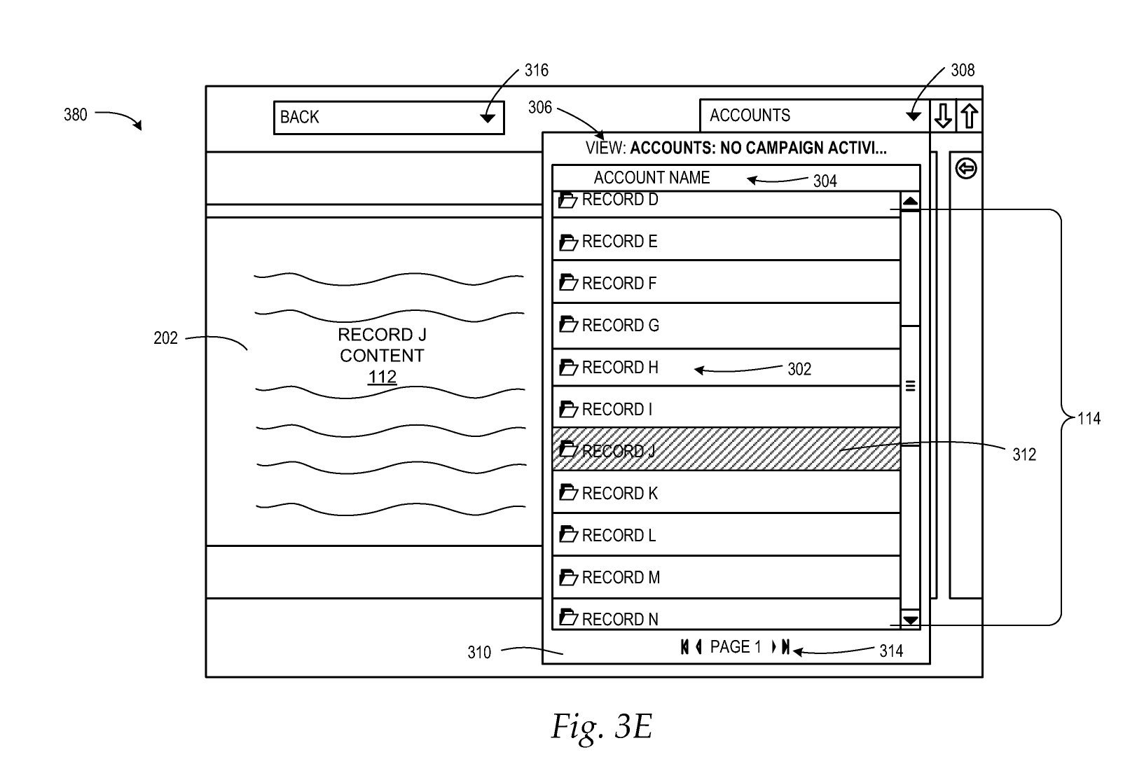

Referring now to FIG. 2, a simplified block diagram 200 of an illustrative example of non-sequential record access from a list of records will be described. For clarity, this illustrative example will be described generally with respect to FIG. 2, and then in greater detail below with respect to corresponding screen diagrams shown in FIGS. 3A-3E. FIG. 2 shows a viewing window 202, viewing window A, at the top of the diagram. In this example, viewing window A corresponds to the homepage of a web application 108 accessed using a web browser 110. For illustrative purposes, this example will be described in the context of a CRM application.

From the homepage of the CRM application, the user views a list 114 of records 120. The list 114 may be compiled by the list management module 116 of the web application 108 according to any number and type of user or administrator defined queries. From the list 114, the user selects a record 120 for viewing. For purposes of this example, the large open arrows that are labeled “1,” “2,” and “3,” represent actions taken by the web application 108 in response to a user input. At action 1, in response to the user selection of record J from the list 114 of records 120, the web application 108 provides the content 112 associated with record J in viewing window 202, represented in this example by viewing window B, or the form window.

In addition to the CRM application retrieving and providing the content 112 to the web browser 110 of the requesting client computer 104, the list management module 116 provides XML list data for caching at the client computer 104. The XML list data may include any quantity and type of list attributes or characteristics captured by the list management module 116. For example, the XML list data may include, but is not limited to, a title or other identification of the list 114 that the record 120 associated with the content 112 being viewed is a member of, the identification of the record 120 currently being viewed, the identifications and sequence of the other records 120 or contents within the list 114, and the number of pages available in the list and current page number from the list 114 containing the currently viewed record 120. These attributes will be further illustrated below with respect to the screen diagrams of FIGS. 3A-3E.

The XML list data 204 may be stored in cache memory at the client computer 104 in context of the open window to facilitate recreation of the list within the new viewing window B. It should be appreciated that in the context of a web application 108, the list data that is being captured is described as XML data or code. However, it is within the scope of the disclosure provided herein that the format of the data corresponds to any type of programming language depending on the specific implementation of the disclosure concepts.

Continuing the example, while the user is viewing the content 112 associated with record J, he or she requests to view the list 114. Rather than returning to the viewing window A to view the list 114, the cached XML data 204 enables the list 114 to be provided within the new viewing window B. Once the user has made a selection of a new record 120 from the list 114, record P in this example, the CRM application retrieves and provides the content 112 associated with record P at action 2 and replaces the record J content with the record P content within the same viewing window B. The XML list data 204 corresponding to the contents and state of the list 114 with respect to the selection of record P is cached for future use. The user may again view and utilize the list 114 of records 120. However, according to this example, the user selects a “back” or “previous” button that triggers a return to the record J contents at action 3.

It should be noted that when the user returns to the previous record 120, the content 112 within the same viewing window B is replaced with the previous content 112, allowing the user to stay within the viewing window 202 being currently viewed without having to close and open other windows. It should also be noted that when the user requests the list 114 while viewing the content 112 associated with record J after returning to the record 120, the cached XML list data 204 that was associated with this particular record 120 allows for the list 114 to open on the appropriate page with the appropriate contents since the state of the list 114 was stored and associated with the content 112 and record 120 being viewed.

It should be appreciated that the disclosure provided herein is not limited to sequence of user inputs and the specific actions 1-3 that are shown and described with respect to FIG. 2 and corresponding FIGS. 3A-3E. For example, using the various aspects described herein, a user may randomly jump around between records 120 on various pages of the list 114, or may sequentially progress through the records 120 of the list 114. The specific inputs and resulting actions described with respect to FIG. 2 and FIGS. 3A-3E were selected and discussed herein for illustrative purposes only and are not to be considered limiting in any way.

FIGS. 3A-3E show illustrative screen diagrams 300, 320, 340, 360, and 380, respectively, representing various user inputs and web application 108 responses according to the example embodiment shown and described above with respect to FIG. 2. Looking at FIG. 3A, screen diagram 300 represents content being displayed in the viewing window 202. The user requests the list 114 of records 120 using a drop down button 308 associated with the various account lists that are available for viewing and interaction. Selection of the drop down button 308 provides the user with a list of titles associated with the available lists 114. After selecting the account list corresponding to the account list title 306, “No Campaign Activity,” a pop-up menu 310, such as a fly-out menu, is displayed over a portion of the viewing window 202. According to this embodiment, the pop-up menu 310 includes the account list title 306 that indicates which account list the user is viewing. An account name title 304 informs the user what the record representations 302 are indicating. In this example, the record representations 302 are the names of the accounts in the list 114, along with type specific icons. In other words, according to this example, the list 114 shown in the pop-up menu 310 includes a list of account names and corresponding icons corresponding to the accounts that have had no campaign activity for a determined quantity of time.

According to other embodiments, the record representations 302 may include any desired identification or information relating to the corresponding record 120. For example, the record representations 302 may include pictures, graphical representations, and/or any other type of informative representations. The record 120 being selected, or the currently viewed record 120, may be highlighted or otherwise distinguished, as shown by reference number 312. In this example, the user is selecting record J.

The list 114 may include multiple pages. As described above, with web applications, a page set has a defined number of items that can be displayed at a time. If the list 114 has more records 120 than a single page is predetermined to display, then the records 120 are listed on multiple pages. According to embodiments disclosed herein, the user may navigate to the next or previous page of the list 114 by clicking on one of the appropriate page buttons 314, if desired, and open records 120 on those pages. To reduce server roundtrips and to enhance performance, requested pages are cached and used for subsequent requests. As will be described below with respect to FIGS. 3D and 3E, the viewing window 202 may include a “Back” button that may be selected to return to the previously displayed record content 112.

It should be appreciated that the specific configuration of the screen diagrams 300, 320, 340, 360, and 380 shown and described herein are not intended to be limiting. Rather, they are shown for illustrative purposes only according to one embodiment. The location, size, names, and other characteristics of the various lists, content, buttons, and other elements of the screen diagrams may be altered or omitted within the scope of this disclosure. As an example, the list 114 shown in FIGS. 3A-3E is implemented as a pop-up menu 310. However, according to alternative embodiments, the list 114 may be permanently presented in the form of a navigation pane within the viewing window 202 or as part of a drop-down menu.

FIG. 3B shows the screen diagram 320 that results from the user's selection of record J from the list 114 in the original viewing window 202. As described above with respect to FIG. 2, after the initial selection of a record 120 from the list 114, the content 112 may be displayed in a new viewing window 202. The content 112 displayed in the new viewing window 202 will be replaced with each subsequent selection of a record 120 from the list 114. According to other embodiments, the content 112 of the original viewing window 202 changes with each selection of a new record 120 from the list 114.

As seen in FIG. 3B, once the user has selected the desired record 120, the corresponding content 112 is displayed and the list 114 is closed or hidden. To request the list 114 again, the user may select the desired list from the drop down button 308. According to one embodiment, the default list that is provided upon selecting the drop down button 308 is the list 114 and page containing the currently viewed record content 112. From this screen diagram 320, the user requests the list 114 and the list 114 is displayed, as shown in the screen diagram 340 of FIG. 3C, utilizing the cached XML list data 204 provided by the list management module 116 upon the selection of the record J in the original viewing window 202. Although the list 114 would be initially displayed on page 1 according to one embodiment since record J is on page 1 of the list, the user in FIG. 3C has selected the appropriate next page button 314 to navigate to page 2 of the list 114. The user is now selecting (non-sequentially) record P from the list 114.

After selecting record P, the screen diagram 360 of FIG. 3D illustrates that the content 112 associated with record P is displayed in the viewing window 202, replacing the content 112 associated with record J, and the list 114 is again removed or otherwise hidden. In this example, the user has decided to return to record J. To do so, the user selects the “Back” button 316 and the content 112 associated with record P is replaced with the content 112 associated with record J, as shown in the screen diagram 380 of FIG. 3E. The content 112 associated with record J is retrieved from cache memory, enhancing the performance of the CRM application and the user experience. When the user again requests to view the list 114, the cached XML list data 204 enables the list 114 to be displayed according to the appropriate account and page corresponding to the record 120 being displayed in the viewing window 202.

It should be understood that while the list 114 of records 120 is kept in memory in the context of the open or current viewing window 202, other embodiments provide for persisting the list back to the server computer 102 for later retrieval. Moreover, it should be noted that because the records 120 that are selected using the list 114 are being loaded in the same viewing window 202, replacing the previous content 112, users may perform other actions on the record 120, such as sending or copying the shortcut. In other words, because each record 120 is presented in a complete format that includes all content as if it had been opened from the home page of the web application 108, users may perform all possible actions with respect to the record 120 being viewed, regardless of the content of the viewing window 202 when the record 120 is opened.

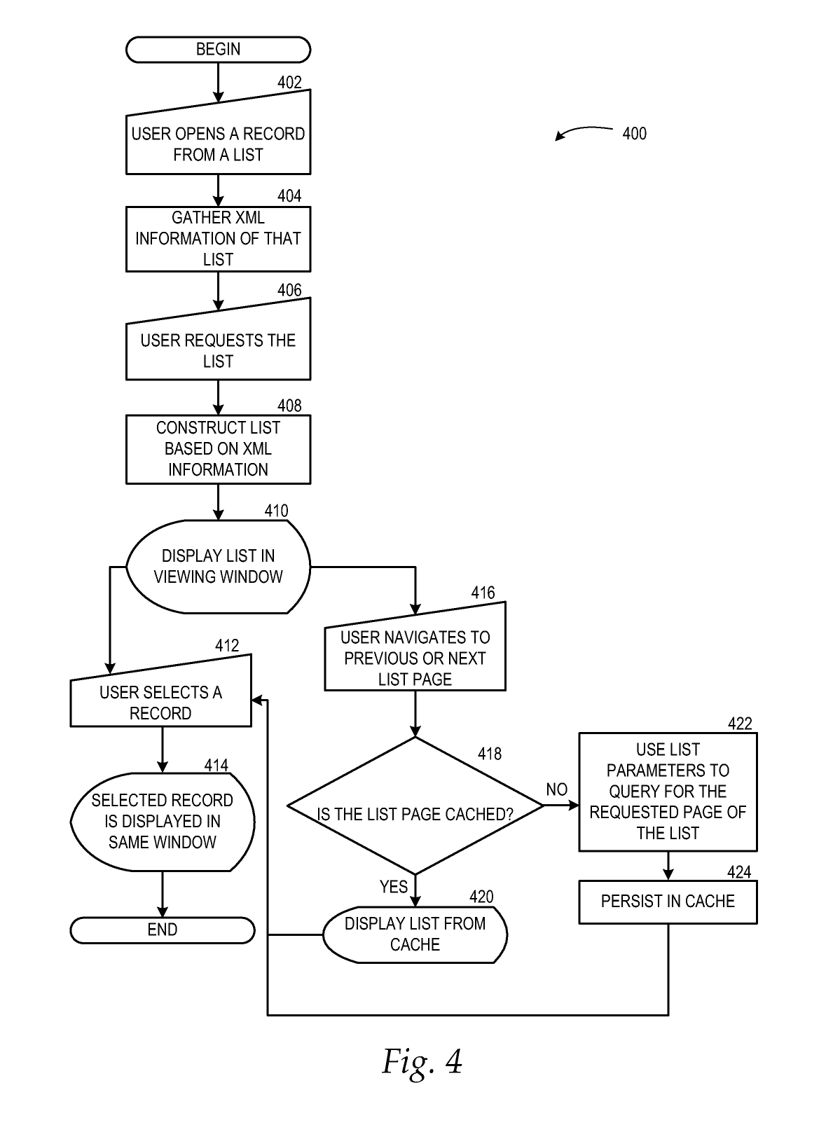

Turning now to FIG. 4, additional details will be provided regarding the embodiments presented herein for providing sequential and non-sequential access to records of a list. In particular, FIG. 4 is a flow diagram showing a routine 400 that shows aspects of the operations performed by the web application 108 in response to actions taken or requested by the user according to one embodiment disclosed herein.

It should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as operations, structural devices, acts, or modules. These operations, structural devices, acts and modules may be implemented in software, in firmware, in special purpose digital logic, and any combination thereof It should also be appreciated that more or fewer operations may be performed than shown in the figures and described herein. These operations may also be performed in a different order than those described herein.

The routine 400 begins at operation 402, where the user opens a record 120 from a list 114. As described above, the user may request the list 114 by selecting the desired list, view the list 114 being displayed in a pop-up menu 310 or navigation pane or other location, navigate to the page of the list 114 containing the desired record 120, and click on the record representation 302 corresponding to the desired record 120. The content 112 associated with the selected record 120 then opens in a viewing window 202. From operation 402, the routine 400 continues to operation 404, where in response to the opening of the record 120, the list management module 116 captures the appropriate XML list data 204.

The user requests the list 114 at operation 406 and the list 114 is constructed at operation 408 using the cached XML list data 204. From operation 408, the routine 400 continues to operation 410, where the list 114 of records 120 is displayed in the viewing window 202. When the list 114 is displayed, the user may take one of two affirmative actions. First, at operation 412, the user may select a record 120. After doing so, the routine 400 continues to operation 414, where the content 112 of the selected record 120 replaces the currently viewed content 112 in the viewing window 202 and the routine 400 ends.

However, at operation 410, if the user does not find the desired record 120 on the current page of the list 114, the routine 400 proceeds to operation 416, where the user navigates to a previous or next page of the list 114 in search of the desired record 120. At operation 418, a determination is made as to whether the requested list page is cached. If so, then the routine proceeds to operation 420, where the list 114 is displayed from cache. From operation 420, the routine 400 continues to operation 412 and continues as described above. However, if at operation 418, a determination is made that the requested list page has not been cached, then the routine 400 proceeds to operation 422, where the parameters of the list 114 corresponding to the current and requested states of the list 114 are used to request the appropriate page of the list 114 from the web application 108. The requested page of the list 114 is retrieved and stored in cache for future use at operation 424. The routine 400 proceeds to operation 412 and continues as described above.

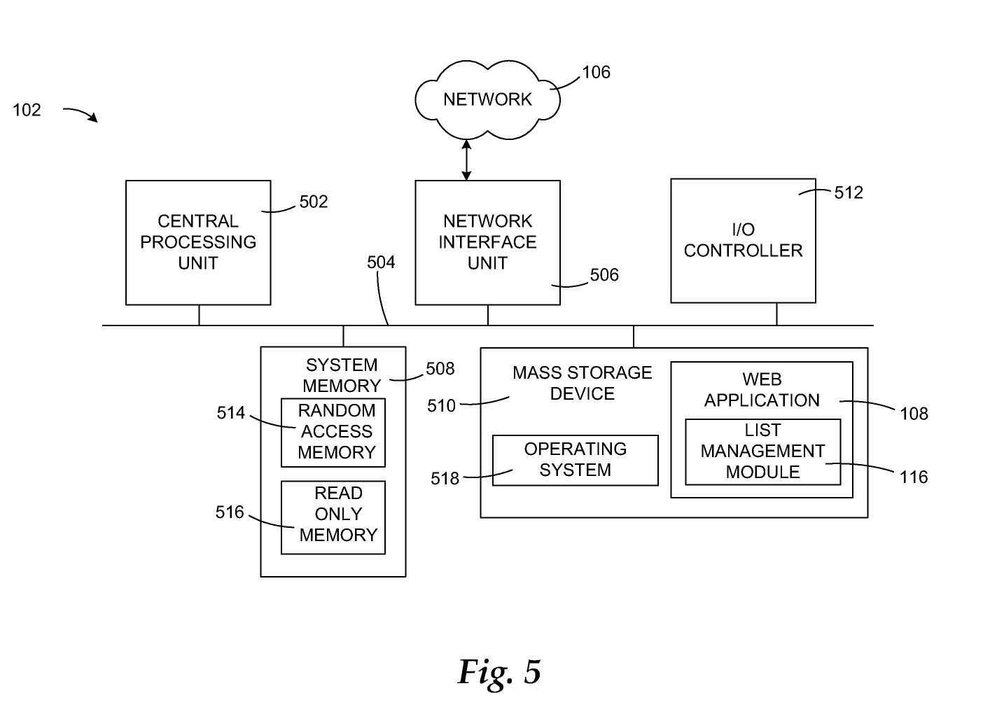

FIG. 5 shows an illustrative computer architecture for a server computer 102 capable of executing the software components described herein for providing sequential and non-sequential access to records 120 in a list 114. The computer architecture shown in FIG. 5 illustrates a conventional desktop, laptop computer, or server computer and may be utilized to execute the web application 108, including the list management module 116, or any of the other software components described herein.

The computer architecture shown in FIG. 5 includes a central processing unit 502 (CPU), a system memory 508, including a random access memory 514 (RAM) and a read-only memory (ROM) 516, and a system bus 504 that couples the memory to the CPU 502. A basic input/output system (BIOS) containing the basic routines that help to transfer information between elements within the server computer 102, such as during startup, is stored in the ROM 516. The server computer 102 further includes a mass storage device 510 for storing an operating system 518, application programs, and other program modules, which will be described in greater detail below.

The mass storage device 510 is connected to the CPU 502 through a mass storage controller (not shown) connected to the bus 504. The mass storage device 510 and its associated computer-readable media provide non-volatile storage for the server computer 102. Although the description of computer-readable media contained herein refers to a mass storage device, such as a hard disk or CD-ROM drive, it should be appreciated by those skilled in the art that computer-readable storage media can be any available computer storage media that can be accessed by the server computer 102.

By way of example, and not limitation, computer-readable storage media may include volatile and non-volatile, removable and non-removable media implemented in any method or technology for storage of information such as computer-readable instructions, data structures, program modules or other data. For example, computer-readable storage media includes, but is not limited to, RAM, ROM, EPROM, EEPROM, flash memory or other solid state memory technology, CD-ROM, digital versatile disks (DVD), HD-DVD, BLU-RAY, or other optical storage, magnetic cassettes, magnetic tape, magnetic disk storage or other magnetic storage devices, or any other medium which can be used to store the desired information and which can be accessed by the server computer 102. As used herein, the term computer-readable storage media does not encompass transitory signals.

According to various embodiments, the server computer 102 may operate in a networked environment using logical connections to remote computers through a network such as the network 520. The server computer 102 may connect to the network 106 through a network interface unit 506 connected to the bus 504. It should be appreciated that the network interface unit 506 may also be utilized to connect to other types of networks and remote computer systems. The server computer 102 may also include an input/output controller 512 for receiving and processing input from a number of other devices, including a keyboard, mouse, or electronic stylus (not shown in FIG. 5). Similarly, an input/output controller may provide output to a display screen, a printer, or other type of output device (also not shown in FIG. 5).

As mentioned briefly above, a number of program modules and data files may be stored in the mass storage device 510 and RAM 514 of the server computer 102, including an operating system 518 suitable for controlling the operation of a networked desktop, laptop, or server computer. The mass storage device 510 and RAM 514 may also store one or more program modules. In particular, the mass storage device 510 and the RAM 514 may store the web application 108 and the list management module 116, as well as any other program modules utilized to implement the various aspects described above. The mass storage device 510 and RAM 514 may also store other program modules and data.

In general, software applications or modules may, when loaded into the CPU 502 and executed, transform the CPU 502 and the overall server computer 102 from a general-purpose computing system into a special-purpose computing system customized to perform the functionality presented herein. The CPU 502 may be constructed from any number of transistors or other discrete circuit elements, which may individually or collectively assume any number of states. More specifically, the CPU 502 may operate as one or more finite-state machines, in response to executable instructions contained within the software or modules. These computer-executable instructions may transform the CPU 502 by specifying how the CPU 502 transitions between states, thereby physically transforming the transistors or other discrete hardware elements constituting the CPU 502.

Encoding the software or modules onto a mass storage device may also transform the physical structure of the mass storage device or associated computer readable storage media. The specific transformation of physical structure may depend on various factors, in different implementations of this description. Examples of such factors may include, but are not limited to: the technology used to implement the computer readable storage media, whether the computer readable storage media are characterized as primary or secondary storage, and the like. For example, if the computer readable storage media is implemented as semiconductor-based memory, the software or modules may transform the physical state of the semiconductor memory, when the software is encoded therein. For example, the software may transform the states of transistors, capacitors, or other discrete circuit elements constituting the semiconductor memory.

As another example, the computer readable storage media may be implemented using magnetic or optical technology. In such implementations, the software or modules may transform the physical state of magnetic or optical media, when the software is encoded therein. These transformations may include altering the magnetic characteristics of particular locations within given magnetic media. These transformations may also include altering the physical features or characteristics of particular locations within given optical media, to change the optical characteristics of those locations. Other transformations of physical media are possible without departing from the scope and spirit of the present description, with the foregoing examples provided only to facilitate this discussion.

Based on the foregoing, it should be appreciated that technologies for providing sequential and non-sequential access to records in a list have been disclosed herein. Although the subject matter presented herein has been described in language specific to computer structural features, methodological acts, and computer readable media, it is to be understood that the aspects of the disclosure defined in the appended claims are not necessarily limited to the specific features, acts, or media described herein. Rather, the specific features, acts and storage mediums are disclosed as example forms of implementing the claims.

The subject matter described above is provided by way of illustration only and should not be construed as limiting. Various modifications and changes may be made to the subject matter described herein without following the example embodiments and applications illustrated and described, and without departing from the true spirit and scope of the present invention, which is set forth in the following claims.

What is claimed is:

1. A computer-implemented method for providing sequential and non-sequential access to a plurality of records represented in a list, the method comprising performing computer implemented operations for:
providing a list comprising a plurality of record representations corresponding to the plurality of records, the plurality of record representations presented sequentially in one or more list pages;
receiving a selection of a first record representation corresponding to a first record from the list;
in response to receiving the selection of the first record representation, providing content associated with the first record within a viewing window;
providing the list while providing the content associated with the first record within the viewing window;
receiving a selection of a second record from the list; and
in response to receiving the selection of the second record, replacing the content associated with the first record with content associated with the second record within the viewing window.

2. The computer-implemented method of claim 1, wherein the method is performed by a web application executing on a server computer, and wherein the selection of the first record and the selection of the second record are received from a remote client computer.

3. The computer-implemented method of claim 1, wherein the list comprises the plurality of record representations presented sequentially in a plurality of list pages such that a subset of the plurality of record representations are presented on each page of the plurality of list pages.

4. The computer-implemented method of claim 1, wherein the plurality of record representations comprises a plurality of record names corresponding to the plurality of records.

5. The computer-implemented method of claim 1, wherein the plurality of record representations comprises a plurality of graphical representations corresponding to the plurality of records.

6. The computer-implemented method of claim 1, wherein providing the list comprises displaying a pop-up menu over the viewing window, the pop-up menu comprising the plurality of record representations presented sequentially in the one or more list pages.

7. The computer-implemented method of claim 1, wherein providing the list comprises displaying a navigation pane within the viewing window, the navigation pane comprising the plurality of record representations presented sequentially in the one or more list pages.

8. The computer-implemented method of claim 1, further comprising:
receiving a request for an alternative list while providing the content associated with the second record within the viewing window, the alternative list comprising different content from the list;
in response to receiving the request for the alternative list, providing the alternative list while providing the content associated with the second record within the viewing window; and
storing list data corresponding to the list in cache memory.

9. The computer-implemented method of claim 8, further comprising:
receiving a request to return to the content associated with the first record within the viewing window;
in response to receiving the request to return to the content associated with the first record, providing the content associated with the first record within the viewing window;
receiving a request for a list comprising a plurality of record representations; and
in response to receiving the request for the list, providing the list according to the list stored in cache memory.

10. The computer-implemented method of claim 1, further comprising storing extensible markup language (XML) list data corresponding to content and state of the list.

11. The computer-implemented method of claim 10, wherein the XML list data corresponding to the content and the state of the list comprises list data corresponding to a list identification, the plurality of record representations listed sequentially in one or more list pages, and a current page of the list on which the first record representation is sequentially presented within the plurality of record representations.

12. A computer-readable storage medium having computer-executable instructions stored thereupon which, when executed by a computer, cause the computer to:
receive a selection of a record from a list comprising a plurality of records;
in response to receiving the selection of the record, capture list data comprising contents and state of the list;
provide content associated with the record from the list; and
provide the list data for recreating the list upon subsequent request for viewing the list and corresponding selection of an alternative record from the list.

13. The computer-readable storage medium of claim 12, wherein the computer-executable instructions comprise a web application, wherein the computer comprises a server computer, and wherein the selection of the record is received by the server computer from a web browser executing on a remote client computer.

14. The computer-readable storage medium of claim 12, wherein the list comprises a plurality of pages and wherein the list data comprises an instruction to display a page of the list containing the record selected upon receiving a request to view the list.

15. The computer-readable storage medium of claim 12, wherein causing the computer to capture and provide list data comprises causing the computer to capture and store XML data corresponding to the contents and state of the list.

16. The computer-readable storage medium of claim 15, wherein the state of the list comprises an identification of the list that associated with the record and a page on which the record is listed sequentially with the plurality of records.

17. The computer-readable storage medium of claim 12, further comprising computer-executable instructions stored thereupon which, when executed by a computer, cause the computer to:
receive a request to view the list;
in response to receiving the request to view the list, provide the list utilizing the list data;
receive a selection of the alternative record from the list; and
in response to receiving the selection of the alternative record from the list, replacing the content associated with the record in a viewing window with content associated with the alternative record.

18. The computer-readable storage medium of claim 17, wherein the alternative record is a non-sequential record with respect to the record.

19. A computer-implemented method for providing non-sequential access to a plurality of records in a list within a web application, the method comprising performing computer implemented operations for:
providing first content within a viewing window;
providing the list concurrently with the first content, the list comprising the plurality of records arranged sequentially within a plurality of list pages;
receiving a selection of a record from the list;
in response to receiving the selection of the record,
retrieving second content associated with the record selected from the list,
replacing the first content within the viewing window with the second content, and
storing XML list data corresponding to the list;
providing a page of the list while providing the second content within the viewing window, the page comprising the record associated with the second content according to the XML list data;
receiving a request for an alternative page of the list;
in response to the request for the alternative page of the list, providing the alternative page of the list;
receiving a selection of a non-sequential record from the alternative page of the list; and
in response to receiving the selection of the non-sequential record, retrieving third content associated with the non-sequential record selected from the list and replacing the second content within the viewing window with the third content.

20. The computer-implemented method of claim 19, wherein the XML data comprises an association between the first content and a first page of the list on which the record associated with the first content is listed, the method the further comprising:
receiving a request to view the first content within the viewing window;
in response to the request to view the first content, replacing the third content with the first content stored in cache memory;
receiving a request to view the list; and
in response to receiving the request to view the list, providing the first page of the list according to the XML data associating the first content with the first page of the list.
